(19) United States
(12) Patent Application Publication
(10) Pub. No.: US 2026/0289155 A1
(43) Pub. Date: Sep. 24, 2026

(54) APPARATUS, INFORMATION PROCESSING SYSTEM, AND INFORMATION PROCESSING METHOD

(71) Applicant: Hiroki KATAOKA, KANAGAWA (JP)

(72) Inventor: Hiroki KATAOKA, KANAGAWA (JP)

(73) Assignee: Ricoh Company, Ltd., Tokyo (JP)

(21) Appl. No.: 19/454,695

(22) Filed: Jan. 21, 2026

(30) Foreign Application Priority Data
Mar. 18, 2025 (JP) 2025-043339

(51) Int. Cl. G06F 40/40; H04N 1/00

(52) U.S. Cl. CPC G06F 40/40; H04N 1/00074

(57) ABSTRACT

An apparatus includes circuitry. The circuitry causes a generative artificial intelligence (AI) to generate a text describing a work detail of a unit of work based on information related to a setting item. The unit of work includes, as an operation target, a set of setting items associated with the apparatus. The set of setting items includes the setting item. The information related to the setting item is stored in a memory for each of the setting items. The circuitry outputs the text generated by the generative AI.

### CROSS-REFERENCE TO RELATED APPLICATION

This patent application is based on and claims priority pursuant to 35 U.S.C. § 119(a) to Japanese Patent Application No. 2025-043339, filed on Mar. 18, 2025, in the Japan Patent Office, the entire disclosure of which is hereby incorporated by reference herein.

### BACKGROUND

### Technical Field

The present disclosure relates to an apparatus, an information processing system, and an information processing method.

### Related Art

A technology has been devised for schedule management of required or periodic works for maintenance of apparatuses, such as image forming apparatuses, to avoid various screen transitions. Specifically, a unit of work is created by consolidating setting items and similar elements that are operated in each work into one unit, and schedule management is performed for this unit of work. As a result, an operator can execute the work by operating the setting items belonging to the registered unit of work, thereby enabling management of periodic works such as daily maintenance work.

To facilitate understanding of the details of each unit of work, a description may be set for each unit of work. Without such a description, the purpose and work details of the set of setting items (i.e., unit of work) may remain unclear until the work actually begins.

When a user manually sets a description for a unit of work, the user needs to understand the purpose and work details of all setting items included in the unit of work and create a text that concisely describes the purpose and work details of the unit of work. Such text creation depends on the number of setting items included in the unit of work and needs to be performed for each unit of work, resulting in a significant workload for the user.

### SUMMARY

The present disclosure described herein provides an apparatus including circuitry. The circuitry causes a generative artificial intelligence (AI) to generate a text describing a work detail of a unit of work based on information related to a setting item. The unit of work includes, as an operation target, a set of setting items associated with the apparatus. The set of setting items includes the setting item. The information related to the setting item is stored in a memory for each of the setting items. The circuitry outputs the text generated by the generative AI.

The present disclosure described herein provides an information processing system including circuitry and a display. The circuitry causes a generative AI to generate a text describing a work detail of a unit of work based on information related to a setting item. The unit of work includes, as an operation target, a set of setting items associated with an apparatus. The set of setting items includes the setting item. The information related to the setting item is stored in a memory for each of the setting items. The circuitry outputs the text generated by the generative AI. The display displays the output text.

The present disclosure described herein provides an information processing method including causing and outputting. The causing includes causing a generative AI to generate a text describing a work detail of a unit of work based on information related to a setting item. The unit of work including, as an operation target, a set of setting items associated with an apparatus. The set of setting items includes the setting item. The information related to the setting item is stored in a memory for each of the setting items. The outputting includes outputting the text generated by the generative AI.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a block diagram illustrating a hardware configuration of an image forming apparatus;

FIG. 2 is a block diagram illustrating a functional configuration of an image forming apparatus;

FIG. 3 is a diagram illustrating a configuration of setting item information;

FIG. 4 is a diagram illustrating a configuration of task information;

FIG. 5 is a sequence diagram of a procedure executed by an image forming apparatus;

FIG. 6 is a diagram illustrating a task editing screen;

FIG. 7 is a diagram illustrating a task editing screen for editing a work unit; and

FIG. 8 is a diagram illustrating a task editing screen for receiving input of a work description.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below.

As used herein, the singular forms “a,” “an,” and “the” are intended to include the plural forms as well, unless the context clearly indicates otherwise. The term “connected/coupled” includes both direct connections and connections in which there are one or more intermediate connecting elements.

For the sake of simplicity, identical or similar reference numerals denote identical or similar elements such as parts and materials having the same functions, and redundant descriptions thereof are omitted unless otherwise required.

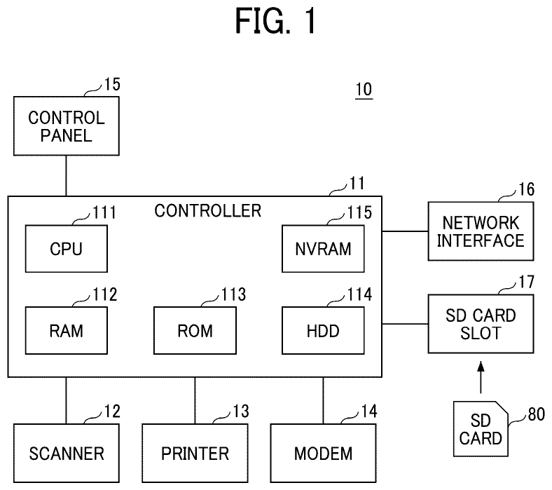

FIG. 1 is a block diagram illustrating a hardware configuration of an image forming apparatus 10.

As illustrated in FIG. 1, the image forming apparatus 10 includes, as hardware resources, a controller 11, a scanner 12, a printer 13, a modem 14, a control panel 15, a network interface 16, and a secure digital (SD) card slot 17.

The controller 11 includes a central processing unit (CPU) 111, a random-access memory (RAM) 112, a read-only memory (ROM) 113, a hard disk drive (HDD) 114, and a nonvolatile random-access memory (NVRAM) 115. The ROM 113 stores various programs and data used by the programs. The RAM 112 is used as a memory area to which a program is loaded and used as a work area for executing the loaded program. The CPU 111 executes the program loaded to the RAM 112 to implement various functions. The HDD 114 stores programs and various data used by the programs. The NVRAM 115 stores, for example, various setting information.

The scanner 12 is a hardware component (an image reading device) that scans documents to obtain image data. The printer 13 is a hardware component (a printing device) that forms images on printing sheets based on print data. The modem 14 is a hardware component that connects the image forming apparatus 10 to a telephone line and enables transmission and reception of image data via facsimile communication. The control panel 15 is a hardware component that includes an input device, such as keys or button, for receiving input from a user, and a display device, such as a liquid crystal panel. The liquid crystal panel may include a touch panel function; in this case, the liquid crystal panel also serves as an input device. The network interface 16 is a hardware component that connects the image forming apparatus 10 to a wired or wireless network, such as a local area network (LAN). The SD card slot 17 is used to read programs stored on an SD card 80. Accordingly, in the image forming apparatus 10, programs stored in the SD card 80, as well as those stored in the ROM 113, may be loaded into the RAM 112 for execution. In addition to, or as an alternative to, the SD card 80, other suitable recording media may be used, such as a compact disc-read-only memory (CD-ROM) or a universal serial bus (USB) drive. In other words, the recording medium corresponding to the SD card 80 is not limited to a specific type. In such cases, an appropriate hardware connection port is used in place of the SD card slot 17, depending on the type of recording medium.

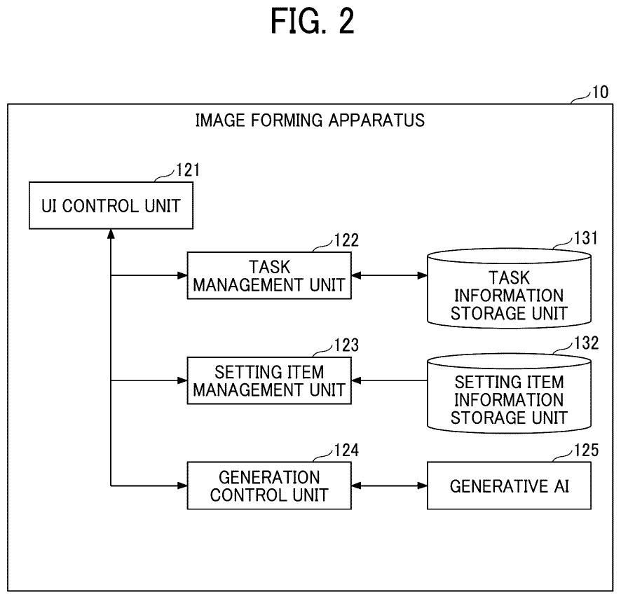

FIG. 2 is a block diagram illustrating a functional configuration of the image forming apparatus 10.

As illustrated in FIG. 2, the image forming apparatus 10 includes a user interface (UI) control unit 121, a task management unit 122, a setting item management unit 123, a generation control unit 124, and a generative artificial intelligence (AI) 125. Each of these functional units is implemented by processing executed by the CPU 111 in accordance with one or more programs installed in the image forming apparatus 10. The image forming apparatus 10 also uses a task information storage unit 131 and a setting item information storage unit 132. Each of these storage units can be implemented by, for example, the HDD 114 or a storage device that is connectable to the image forming apparatus 10 via a network.

The setting item information storage unit 132 stores information related to a setting item, which may be referred to as “setting item information” in the following description, for each of setting items related to the image forming apparatus 10. The setting item refers to a parameter that is included in the image forming apparatus 10 in advance and whose setting can be changed. Specifically, the “setting item” in the present embodiment refers to an item that is changed by the user for the purpose of correcting the operation result of the apparatus at the time of maintenance of the apparatus or before the apparatus is operated. Examples of setting items of the image forming apparatus 10 include: printing position, conveyance speed of printing sheets, color density during printing, margin size, paper feed settings, print color settings (e.g., monochrome, color), and print sheet settings (e.g., coated paper, matte paper).

Examples of setting items of an apparatus other than the image forming apparatus 10 include: error detection condition settings, period for automatic backup of internal data, network settings, execution quality settings (e.g., speed priority or quality priority), output settings (e.g., volume, screen brightness), and settings for sleep mode and automatic power-off.

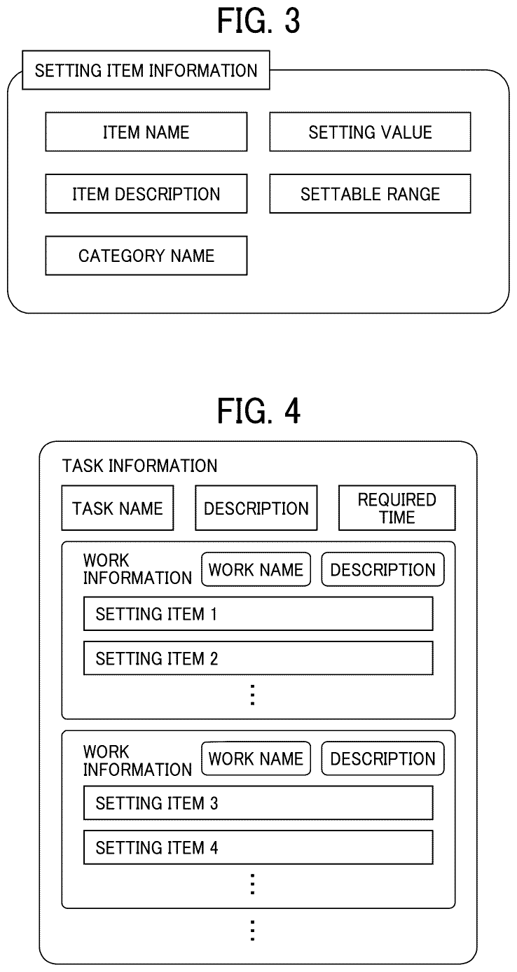

FIG. 3 is a diagram illustrating a configuration of setting item information.

As illustrated in FIG. 3, one piece of setting item information includes an item name, a setting value, an item description, a settable range, and a category name. The item name refers to the name of the setting item. The setting value refers to the current value assigned to the setting item. The item description refers to text (description) used to describe the impact of changing the value of the setting item, specifically, what changes occur and how the changes occur. For example, the item description for a setting item for changing the printing position indicates, to the user, a result obtained by operating the setting item, such as a text “If this setting item is adjusted, the position of the print image changes. A positive (+) value moves the image to the right, while a negative (−) value moves the image to the left.” The settable range refers to information indicating a range of values that can be set as the setting value. The category name refers to the name of a classification (category) to which the setting item belongs when the setting items are classified based on commonality of related functions, for example. Each setting item belongs to any one of the categories.

Referring back to FIG. 2, the task information storage unit 131 stores information related to a task, which may be referred to as “task information” in the following description, for each task that is set (created) by the user.

One task is a set of one or more “work units” performed for one maintenance of the image forming apparatus 10. A task is created for each type of maintenance. One task includes information related to “work units,” which may be referred to as “work information” in the following description, in the execution order within the task. The “work unit” is an example of a unit of work that includes, as an operation target, a set of setting items associated with the image forming apparatus 10, typically for purposes such as maintenance of the image forming apparatus 10. The “work unit” refers to a collection of adjustment items that need to be changed for a specific purpose and the effects of those changes, such as adjustments for printing on a special sheet, but is not limited thereto. A task that is a set of “work units” is also an example of a unit of work that includes, as an operation target, a set of setting items associated with the image forming apparatus 10.

In other words, the task function includes three elements: setting items, work units, and tasks. The setting item is the smallest element, the “work unit” is present as an element in which one or more setting items are collected, and a collection of one or more “work units” is present as a “task.” The “task” can be registered in an apparatus (e.g., the image forming apparatus 10) or a server and can be given information such as a description. The “operation” refers to changing the value of an adjustment item, and the “operation target” is a setting item.

The image forming apparatus 10 can display a screen for each task. On a single screen corresponding to a certain task, values can be set or changed for all setting items belonging to the task. In this way, the maintenance person can operate the setting items related to the task without performing operations for various screen transitions when a certain task is performed. The “all setting items belonging to the task” refers to setting items belonging to all the work units belonging to the task.

FIG. 4 is a diagram illustrating a configuration of task information.

The task information of one task includes a task name, a description, a required time, and work information for each of work units of the task.

The order of work information in the task information corresponds to the execution order of work units within the task. The task name refers to the name of a task. The description refers to text indicating the details of the task (work details), and is a target of automatic generation in the present embodiment. The required time refers to a time required to execute the task.

The work information of a work unit includes a work name, a description, and item names of setting items operated within the work unit, such as “setting item 1,” “setting item 2,” “setting item 3,” and “setting item 4” in FIG. 4. The work name refers to the name of the work unit, and the description refers to text describing the details of the work unit (work details).

The description of each work unit may also be automatically generated.

Referring back to FIG. 2, the UI control unit 121 controls, for example, display of a screen on the control panel 15, reception of input from a user via the screen, and the entire processing in response to the input from the user. The UI control unit 121 also outputs a result of processing executed in response to the input from the user. For example, the UI control unit 121 outputs a description of the automatically generated task or work unit.

The task management unit 122 reads task information from the task information storage unit 131 and writes task information to the task information storage unit 131.

The setting item management unit 123 reads setting item information from the setting item information storage unit 132 and writes setting item information to the setting item information storage unit 132.

When the automatic generation of a description is instructed for a task or a work unit, the generation control unit 124 causes the generative AI 125 to generate the description based on the setting item information stored in the setting item information storage unit 132 for each of the setting items belonging to the task or the work unit. For example, setting an automatically generated description for a task refers to the following series of processes:
(1) inputting all descriptions individually included in all pieces of work information included in a task to the generative AI 125 to generate a summarized content; and
(2) executing a series of processes up to registering the generated description as description details that can be registered for each task.

Prior to executing this series of processes, each setting item has a description (item description) corresponding to the respective setting item, as described above.

The generative AI 125 is a machine-learning model (for example, a neural network) that has been trained in advance and generates, in response to an instruction to generate a description of a task or a work unit from the generation control unit 124, a description based on the generation instruction. For example, a large language model (LLM) may be used as the generative AI 125. The LLM is a machine learning model that has learned natural language processing using a large amount of text data. The LLM is used in many natural language processing (NLP) tasks, such as generation of responses to specific questions, automatic generation of sentences, summarization of text, translation, and emotion analysis. Further, the LLM may be used in various fields such as education, entertainment, customer service, and product development. A generative AI outside the image forming apparatus 10 may be used as the generative AI 125. The generative AI outside the image forming apparatus 10 refers to, for example, a generative AI that functions in a computer connected to the image forming apparatus 10 via a network.

A procedure that is performed by the image forming apparatus 10 is described below.

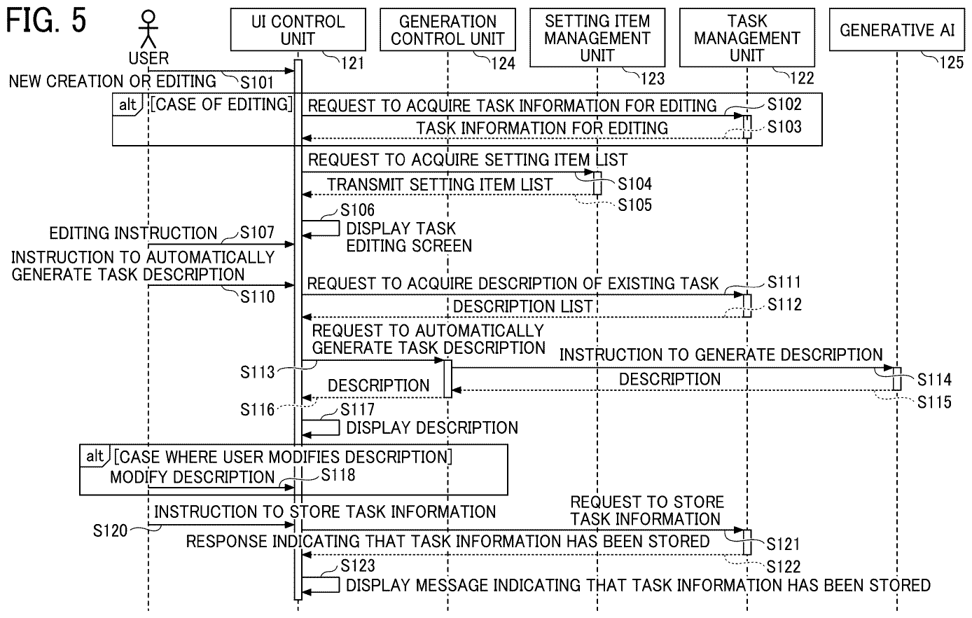

FIG. 5 is a sequence diagram of a procedure executed by the image forming apparatus 10.

At the start of the procedure illustrated in FIG. 5, a task screen is displayed on the control panel 15. The task screen refers to a screen that allows a user to select either creation of a new task or editing of an existing task, and includes a new creation button, an edit button, and a list of existing tasks. The list of existing tasks refers to a list of tasks whose task information is stored in the task information storage unit 131, and is a display element that allows the user to select an existing task to edit. The user inputs, for example, instructions to the image forming apparatus 10 through the control panel 15.

In step S101, the UI control unit 121 receives pressing of the new creation button or the edit button from the user.

When the new creation button is pressed, that is, when creation of a new task is instructed, the process proceeds to step S104. By contrast, when the edit button is pressed, that is, when editing of an existing task is instructed, in step S102, the UI control unit 121 requests the task management unit 122 to acquire task information of the task selected for editing on the task screen. In step S103, the task management unit 122 acquires the task information (FIG. 4) of the task from the task information storage unit 131, and transmits the task information to the UI control unit 121. Subsequently, the process proceeds to step S104. The task information includes the task name, the description, and the required time of the task, and work information of each work unit belonging to the task.

In step S104, the UI control unit 121 requests the setting item management unit 123 to acquire a setting item list including setting item information of all the setting items. In step S105, the setting item management unit 123 acquires the setting item list including the setting item information of all the setting items from the setting item information storage unit 132, and transmits the acquired setting item list to the UI control unit 121. In step S106, the UI control unit 121 displays a task editing screen on the control panel 15 based on the acquired information.

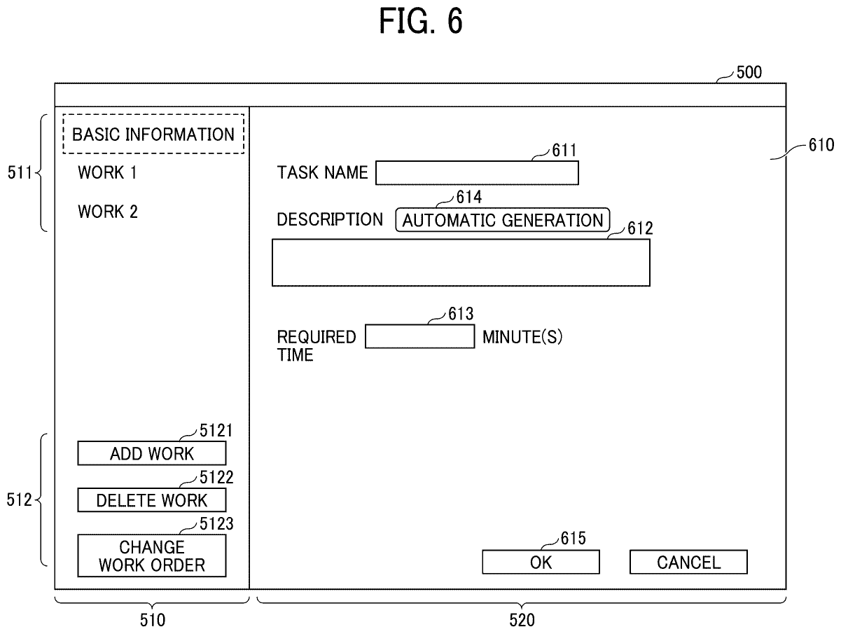

FIG. 6 is a diagram illustrating a task editing screen.

In FIG. 6, a task editing screen 500 is a screen for receiving an operation for creating a new task or editing an existing task, and includes a control area 510 and an editing area 520. A task to be created or edited on the task editing screen 500 may be referred to as a “target task,” and task information of the target task may be referred to as “target task information” in the following description.

The control area 510 includes an editing target selection area 511 and a task configuration change area 512. The editing target selection area 511 is an area that allows the user to select an editing target within the editing area 520. When the target task does not include any work unit (e.g., before any work unit is added to the target task during new task creation), the only option to be edited is the basic information of the target task, such as the task name, the description, and the required time. By contrast, when the target task includes one or more work units (for example, when an existing task is edited or when one or more work units are added to a newly created task), the options to be edited are the basic information of the target task and each work unit belonging to the target task. In the editing target selection area 511, “basic information” is an option corresponding to the basic information of the task. “Work unit 1” and “work unit 2” are options corresponding to work units belonging to the target task, and the work name of each work unit is a label.

The task configuration change area 512 is an area for receiving instructions to change the configuration of the work units of the target task, and includes buttons 5121 to 5123. The button 5121 is a button for receiving instructions to add a work unit to the target task. When the button 5121 is pressed, the UI control unit 121 displays a pop-up screen for receiving input of a work name. When a work name is input to the pop-up screen, the UI control unit 121 adds the work information including the input work name to the target task information and adds the option corresponding to the work unit to the editing target selection area 511. The button 5122 is a button for receiving instructions to delete a work unit belonging to the target task, and is operable when any work unit is selected in the editing target selection area 511. When the button 5122 is pressed, the UI control unit 121 deletes the work information of the selected work unit from the target task information and deletes the option corresponding to the work unit from the editing target selection area 511. The button 5123 is a button for receiving instructions to rearrange the order of work units within the target task, and is operable when two or more work units belong to the target task. When the button 5123 is pressed, for example, the UI control unit 121 allows the order of options corresponding to the work units to be rearranged in the editing target selection area 511. When an instruction to rearrange the order of work units is input by the user, the UI control unit 121 rearranges the order of work information in the target task information in response to the instruction.

The editing area 520 is an area in which a screen for editing the option (editing target) selected in the editing target selection area 511 is displayed. In FIG. 6, since “basic information” corresponding to the target task is selected in the editing target selection area 511, a basic information editing screen 610 is displayed in the editing area 520.

The basic information editing screen 610 is a screen for receiving input of basic information of the target task, and includes a task name input area 611, a description input area 612, a required time input area 613, and buttons 614 and 615. The task name input area 611 is an area for receiving input of the task name of the target task. The description input area 612 is an area for receiving input of the description of the target task. The required time input area 613 is an area for receiving input of the required time for the target task. In the case of editing an existing task, the current setting values of the target task are displayed in advance in these areas. The button 614 is a button for receiving instructions to automatically generate a description, and is operable when the target task includes one or more setting items. The button 615 is a button for receiving instructions to store the editing result of the target task information.

In step S107 of FIG. 5, the UI control unit 121 receives editing of the target task information through the task editing screen 500. For example, the UI control unit 121 receives input of the task name, the description, and the required time of the target task through the task name input area 611, the description input area 612, and the required time input area 613, respectively, of the basic information editing screen 610. The user may input a description created by the user to the description input area 612, or may cause a description to be automatically generated by pressing the button 614. When the user presses the button 614, the automatically generated description is displayed in the description input area 612. The user can modify the displayed description.

The UI control unit 121 receives addition of a work unit to the target task, deletion of a work unit from the target task, and rearrangement of the order of work units of the target task through the task configuration change area 512.

When an option corresponding to any one of the work units belonging to the target task is selected in the editing target selection area 511, the UI control unit 121 displays a work editing screen in the editing area 520 to receive editing of work information of the work unit corresponding to the selected option. In the following description, the work unit corresponding to the selected option may be referred to as “target work unit” and the work information of the target work unit may be referred to as “target work information.”

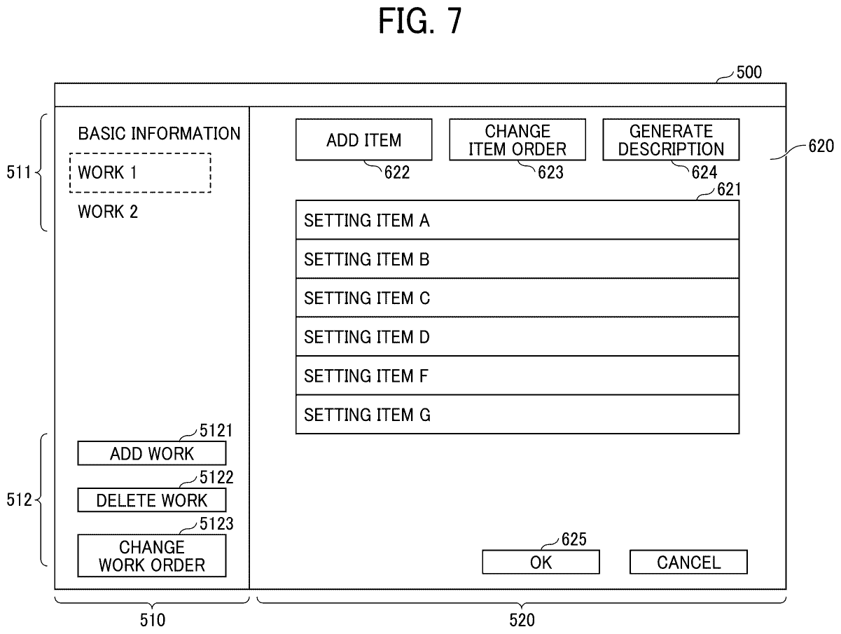

FIG. 7 is a diagram illustrating a task editing screen for editing a work unit.

In the editing area 520 of the task editing screen 500 illustrated in FIG. 7, a work editing screen 620 is displayed. The work editing screen 620 includes a list 621 and buttons 622 to 625.

The list 621 is a series of item names of setting items belonging to the target work unit. In the case of new task creation, the details of the list 621 is empty in the initial state. By contrast, in the case of editing an existing task, a list of item names included in the target work information is displayed in the list 621 in the initial state.

When the button 622 is pressed, the UI control unit 121 displays, on the control panel 15, a pop-up screen that allows the user to select a setting item to be added to the target work information, based on the setting item list acquired in steps S104 and S105. The pop-up screen includes all the setting items as options. When one or more setting items are selected through the pop-up screen, the UI control unit 121 adds the item name of the selected setting item to the list 621.

When the button 623 is pressed, the UI control unit 121 allows the order of setting items to be rearranged in the list 621. When an instruction to rearrange the order of setting items is input by the user, the UI control unit 121 rearranges the order of the setting items in the list 621 in accordance with the instruction. The order of the setting items in the work unit indicates the order of the setting items as operation targets in the work unit.

When the button 624 is pressed, the UI control unit 121 displays a work description editing screen for receiving input of a description of the target work unit in the editing area 520.

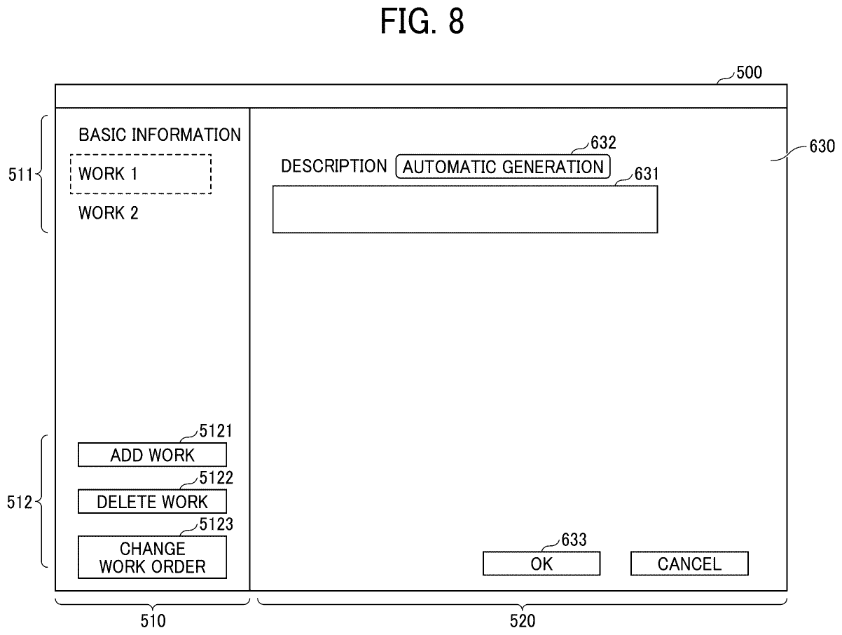

FIG. 8 is a diagram illustrating a task editing screen for receiving input of a work description.

In the editing area 520 of the task editing screen 500 illustrated in FIG. 8, a work description editing screen 630 is displayed. The work description editing screen 630 includes a description input area 631 and buttons 632 and 633. The description input area 631 is an area for receiving input of a description of a target work unit. The button 632 is a button for receiving instructions to automatically generate a description of the target work unit. The user may input a description created by the user to the description input area 631, or may cause a description to be automatically generated by pressing the button 632.

When the user presses the button 632, the automatically generated description is displayed in the description input area 631. The user can modify the displayed description. When the button 633 is pressed, the UI control unit 121 stores the description included in the description input area 631 in the RAM 112, and redisplays the work editing screen 620 (FIG. 7) in the editing area 520. In this case, the work editing screen 620 is redisplayed with the input previously made to the work editing screen 620 maintained. When the button 625 of the work editing screen 620 is pressed, the UI control unit 121 reflects the editing result of the target work information in the target task information and redisplays the basic information editing screen 610 (FIG. 6) in the editing area 520. In this case, the basic information editing screen 610 is redisplayed with the input previously made to the basic information editing screen 610 maintained. The editing result of the target work information includes the details displayed on the work editing screen 620 and the description of the work unit stored in the RAM 112.

In step S110 of FIG. 5, the user presses the button 614 of the basic information editing screen 610 (FIG. 6) to instruct automatic generation of a description of the target task while the target task includes one or more work units, each work unit including one or more setting items. At this time, the UI control unit 121 may cause the user to input an instruction, which may be referred to as a “user instruction” in the following description, regarding the automatic generation of the description. In this case, the UI control unit 121 displays, on the control panel 15, a pop-up screen for receiving a user instruction in response to the pressing of the button 614. The pop-up screen includes a check button for selecting whether input of a user instruction is required and a text box for receiving input of a user instruction when input of a user instruction is required. The user instruction refers to an instruction to the generative AI 125 when generating a description, and may be input in a free form (in a natural language). For example, a text such as “add to the description that the task is intended to adjust the printing accuracy of the image forming apparatus” may be input as the user instruction.

In step S111, the UI control unit 121 requests the task management unit 122 to acquire the description of an existing task. In step S112, the task management unit 122 acquires the description of each piece of task information (FIG. 4) stored in the task information storage unit 131, and transmits a list of the acquired descriptions, which may be referred to as a “description list” in the following description, to the UI control unit 121.

In step S113, the UI control unit 121 transmits a request to generate a description of the target task to the generation control unit 124. The generation request includes the setting item information of all the setting items belonging to the target task, which may be referred to as a “setting item information list” in the following description, and a description list of all the setting items belonging to the target task. When the user instruction is input, the generation request also includes the user instruction. In response to the generation request, in step S114, the generation control unit 124 inputs a prompt as an instruction to generate a description to the generative AI 125. An example of the prompt is as follows.
<Example of prompt begins.>
Generate a description for a task including the following setting items.
{Setting item information list}
The description is a sentence in the following format.
{Description list}
In generating the description, please consider the following instruction.
{User instruction}
<Example of prompt ends.>

The setting item information list is inserted to the {setting item information list} section of the prompt, the description list is inserted to the {description list} section of the prompt, and the user instruction is inserted to the {user instruction} section of the prompt. The information for each setting item included in the setting item information list may not be all of the setting item information (FIG. 3). For example, the information may include the item description alone, or may further include the item name and the category name.

Such a prompt indicates an instruction to generate a description for a task for performing setting for a setting item group related to the setting item information list, with the description list as an example (reference), in accordance with a user instruction.

The generative AI 125 generates text as a description based on learned parameters when the prompt is input. In step S115, the generative AI 125 outputs the generated description to the generation control unit 124. In step S116, the generation control unit 124 transmits the description to the UI control unit 121. In step S117, the UI control unit 121 displays (outputs) the description in the description input area 612 of the basic information editing screen 610.

The user refers to the displayed (automatically generated) description and examines whether to modify the description. When the description is to be modified, in step S118, the user modifies the description by editing the description in the description input area 612.

A work description can be generated by the same procedure as that of steps S110 to S118. In this case, in step S110, the user presses the button 632 of the work description editing screen 630 (FIG. 8). In steps S111 and S112, the UI control unit 121 acquires a list of existing work descriptions from the task management unit 122. The generation request in step S113 includes the setting item information of all the setting items belonging to the target work unit as the setting item information list, and includes a work description list. When the user instruction is input, the generation request also includes the user instruction. Steps S114 to S116 may be executed similarly to the case of the task. In step S117, the UI control unit 121 displays (outputs) the generated description in the description input area 631 of the work description editing screen 630 (FIG. 8).

In step S120, the user inputs an instruction to store target task information by pressing the button 615 of the basic information editing screen 610 (FIG. 6) after completing the operation for creating or editing the target task information. In step S121, the UI control unit 121 transmits a request to store the target task information to the task management unit 122. The storage request includes the target task information. In step S122, the task management unit 122 stores the target task information in the task information storage unit 131, and transmits to the UI control unit 121 a response indicating that the target task information has been stored. In the case of editing existing task information, the task information previously stored in the task information storage unit 131 is overwritten.

In step S123, the UI control unit 121 displays, on the control panel 15, a message indicating that the target task information has been stored.

A description is given below of an example of input information and output information in the case of automatically generating a task description.

### Case of Task Including Two Setting Items

This task includes the following two setting items, 1 and 2. Text in quotation marks of each of the setting items 1 and 2 indicates an item description of the corresponding setting item.

Setting item 1: “This is a setting item for adjusting the printing position of a print target. Adjust this setting when the printing position is misaligned.”

Setting item 2: “This is a setting item for adjusting the print magnification of a print target. Adjust this setting when the print image is excessively large or excessively small.”

In this case, for example, a description as follows is automatically generated.

Generation result: “This is a task for adjusting the printing position and print magnification of a print target. Execution of this task is recommended when there is a misalignment in the print image or when the size of the print image is excessively large or excessively small.”

### Case of Task Including Three Setting Items

This task includes the following setting item in addition to the setting items 1 and 2.

Setting item 3: “This is a setting item for adjusting the ink density. Adjust this setting when adjusting the density of a print target.”

In this case, for example, a description as follows is automatically generated.

Generation result: “This is a task for improving the quality of a print target. Execution of this task is recommended when adjustment of misalignment or density of the print image is desired.”

### Case Where User Instruction is Input for Task Including Three Setting Items

It is assumed that the following user instruction is further input for the task including the setting items 1 to 3.

User instruction: “This task is intended to adjust accuracy according to print targets for the day and is a task performed first thing every morning.”

In this case, for example, a description as follows is automatically generated.

Generation result: “This task is intended to adjust daily printing accuracy and should be executed first thing every morning. This task improves accuracy by adjusting the printing position, print magnification, and ink density in this order.”

In this manner, the user inputs the purpose of the task as the user instruction in addition to the description of each setting item (item description), and thus the description generation result is closer to the details desired by the user.

As described above, a text describing the work details of a unit of work, such as a task or a work unit, that includes, as an operation target, a set of setting items associated with an apparatus can be automatically generated based on information related to each setting item belonging to the unit of work. Accordingly, the workload associated with setting a text describing the work details of a unit of work that includes, as an operation target, a set of setting items associated with an apparatus can be reduced.

Since the work details of a unit of work depends on the setting items as operation targets in the unit of work, a highly appropriate description can be automatically generated based on the information of the setting items.

In the present embodiment, the UI control unit 121 is an example of an output unit.

The present embodiment may be applied to apparatuses other than image forming apparatuses, provided that the apparatus requires a setting operation for setting items. For example, the present embodiment may be applied to output devices such as a projector (PJ), an interactive whiteboard (IWB; an electronic whiteboard having a blackboard function enabling mutual communication), and digital signage, or may be applied to a head-up display (HUD), an industrial machine, an imaging device, a sound collection device, a medical device, a networked home appliance, a laptop personal computer (PC), a mobile phone, a smartphone, a tablet terminal, a game console, a personal digital assistant (PDA), a digital camera, a wearable PC, or a desktop PC.

Some or all of the functions of the image forming apparatus 10 may be included in one or more computers connected to the image forming apparatus 10 via a network. In this case, the present embodiment may be implemented by an information processing system including the image forming apparatus 10 and the one or more computers. In this case, a display unit that displays information such as a description may be included in the image forming apparatus 10 or any computer.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a recording medium such as a CD-ROM or digital versatile disk (DVD), and/or the memory of an FPGA or ASIC.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The following are examples of aspects of the present disclosure.

According to a first aspect, an apparatus includes a generation control unit and an output unit. The generation control unit causes a generative AI to generate a text describing a work detail of a unit of work based on information related to a setting item. The unit of work includes, as an operation target, a set of setting items associated with the apparatus. The information related to the setting item is stored in a storage unit for each of the setting items. The output unit outputs the text generated by the generative AI.

According to a second aspect, in the apparatus of the first aspect, the information related to the setting item includes a description of the setting item.

According to a third aspect, in the apparatus of the first or second aspect, when causing the generative AI to generate the text, the generation control unit inputs, to the generative AI, an example text indicating a work detail of another unit of work stored in the storage unit in association with another unit of work.

According to a fourth aspect, in the apparatus of any one of the first to third aspects, when causing the generative AI to generate the text, the generation control unit inputs, to the generative AI, an instruction input by a user, the instruction being related to generation of the text.

According to a fifth aspect, an information processing system includes a generation control unit, an output unit, and a display unit. The generation control unit causes a generative AI to generate a text describing a work detail of a unit of work based on information related to a setting item. The unit of work includes, as an operation target, a set of setting items associated with an apparatus. The information related to the setting item is stored in a storage unit for each of the setting items. The output unit outputs the text generated by the generative AI. The display unit displays the text output by the output unit.

According to a sixth aspect, an information processing method executed by an apparatus includes a generation control step and an output step. The generation control step includes causing a generative AI to generate a text describing a work detail of a unit of work based on information related to a setting item. The unit of work includes, as an operation target, a set of setting items associated with the apparatus. The information related to the setting item is stored in a storage unit for each of the setting items. The output step includes outputting the text generated by the generative AI.

According to a seventh aspect, a program for causing an apparatus to execute a generation control step and an output step. The generation control step includes causing a generative AI to generate a text describing a work detail of a unit of work based on information related to a setting item. The unit of work includes, as an operation target, a set of setting items associated with the apparatus. The information related to the setting item is stored in a storage unit for each of the setting items. The output step includes outputting the text generated by the generative AI.

1. An apparatus, comprising circuitry configured to:
cause a generative artificial intelligence (AI) to generate a text describing a work detail of a unit of work based on information related to a setting item, the unit of work including, as an operation target, a set of setting items associated with the apparatus, the set of setting items including the setting item, the information related to the setting item being stored in a memory for each of the setting items; and
output the text generated by the generative AI.

2. The apparatus according to claim 1, wherein the information related to the setting item includes a description of the setting item.

3. The apparatus according to claim 1, wherein, when causing the generative AI to generate the text, the circuitry is configured to input, to the generative AI, an example text indicating a work detail of another unit of work stored in the memory in association with said another unit of work.

4. The apparatus according to claim 1, wherein, when causing the generative AI to generate the text, the circuitry is configured to input, to the generative AI, an instruction input by a user, the instruction being related to generation of the text.

5. An information processing system, comprising:
circuitry configured to:
cause a generative AI to generate a text describing a work detail of a unit of work based on information related to a setting item, the unit of work including, as an operation target, a set of setting items associated with an apparatus, the set of setting items including the setting item, the information related to the setting item being stored in a memory for each of the setting items; and
output the text generated by the generative AI; and
a display to display the output text.

6. An information processing method, comprising:
causing a generative AI to generate a text describing a work detail of a unit of work based on information related to a setting item, the unit of work including, as an operation target, a set of setting items associated with an apparatus, the set of setting items including the setting item, the information related to the setting item being stored in a memory for each of the setting items; and
outputting the text generated by the generative AI.
